(19) United States
(12) Patent Application Publication
(10) Pub. No.: US 2025/0022159 A1
(43) Pub. Date: Jan. 16, 2025

(54) Data processing method onboard a machine using database storing definition data of landmark objects along a predetermined path of the machine, associated data processing device and computer program

(71) Applicant: GTS FRANCE, Vélizy-Villacoublay (FR)

(72) Inventors: Philippe LAVIRON, BORDEAUX (FR); Alex ZHANG, BEIJING (CN); Jeffrey YU, BEIJING (CN); Fiona ZHAO, BEIJING (CN); Rui GAO, BEIJING (CN)

(21) Appl. No.: 18/772,121

(22) Filed: Jul. 13, 2024

(30) Foreign Application Priority Data
Jul. 13, 2023 (FR) 2307544

(51) Int. Cl. G06T 7/70; G01S 17/89; G06V 10/70

(52) U.S. Cl. CPC G06T 7/70; G01S 17/89; G06V 10/70

(57) ABSTRACT

Onboard a machine adapted to move on one predetermined path, a database stores definition data of landmark objects along the path and associated to its 3D geographical coordinates and a capture block provides images of the scene in front of the machine. The capture block includes a teledetection block adapted to create an image from received echos and to calculate from the echoes, direction and distance, relative to the machine, of the echoing object. The followings steps are iterated: capturing least one image from the teledetection block; identifying in the image a landmark object as a function of landmark object definition data in the database; using the image from the teledetection block, determining direction and distance, relative to the machine, of the identified landmark object; determining the current 3D position of the machine as a function of the determined direction and distance relative to the machine and of the 3D geographical coordinates associated with the identified landmark object in the database.

### CROSS-REFERENCE TO RELATED APPLICATION

This application claims priority to foreign French patent application No. FR 2307544, filed on Jul. 13, 2023, the disclosure of which is incorporated by reference in its entirety.

### FIELD OF THE INVENTION

The invention lies in the field of a machine adapted to move on at least one predetermined path, for example a train, performing autonomous tasks such as autonomous positioning or obstacle detection.

### BACKGROUND

For application of localization, odometer with discrete localization is able to achieve autonomous train positioning. Tags or balises are used to perform the discrete localization to correct the odometer. However, tags and balises are physical items that require installation and maintenance. GNSS signals are not usable everywhere: there is no GNSS signal reception in the tunnels, or in metro lines with most of the tracks underground.

For application of obstacle detection, in case there is position uncertainty of the train, the facility very close to the train clearance may be regarded as obstacle by mistake, e.g. station platform.

There is thus a need of a solution that alleviates these drawbacks.

### SUMMARY

To this end, according to a first aspect, the present invention describes a data processing method implemented by an electronic data processing device onboard a machine adapted to move on at least one predetermined path; said data processing device including: a database storing definition data of landmark objects along the predetermined path definition data of each landmark object being associated to its 3D geographical coordinates; a capture block providing images of the scene in front of the machine, said capture block including at least a teledetection block adapted for emitting waves towards the path in front of the machine, for receiving echoes of emitted waves from at least one echoing object, to create an image from the received echos and to calculate from said waves and echoes, direction and distance, relative to the machine, of said echoing object; said method comprising the iterated following steps of:
a/ capturing by the capture block a set of images of the current scene comprising at least one image from the teledetection block;
b/ identifying in said image a landmark object as a function of landmark object definition data in the database;
c/ using the image from the teledetection block, determining direction and distance, relative to the machine, of the identified landmark object;
d/ determining the current 3D position of the machine as a function of said determined direction and distance relative to the machine and of the 3D geographical coordinates associated with the identified landmark object in the database.

The invention uses exiting physical items or simple geometry figures along the predetermined path, typically the track, and obtains absolute position from these physical items.

In embodiments, such a method will also comprise at least one of the following characteristics:
based on a roughly estimated position of the machine, the following steps are performed in step b:
   determining, among the landmark objects defined in the database, a subset of the landmark objects distant at most of a threshold distance from said roughly estimated position of the machine;
   the identification of a landmark object being performed only considering the determined subset as comprising the landmark object to be identified excluding the landmark objects out of the subset;
the capture block further includes a camera and the set of images of the current scene includes an image from the camera and an image from the teledetection block,
   the identifying of the landmark object is performed in the image from the camera; and
   a projection of the image from the teledetection block into the referential of the video image is performed in order to match the representation of the identified landmark object in both images;
   the determination of the direction and distance, relative to the machine, of the identified landmark object is achieved based upon the matched representation of the identified object in the image from the teledetection block;
the machine is a railway machine and said landmark objects includes objects among: QR codes, station platforms, marker boards, flood gates, geometry figures, signals;
landmark objects includes objects with respective geometrical form each associated wherein the database storing a correspondence between the geometrical form and a respective number, said method comprising the following steps:
identifying successive identified geometric form objects along the path;
deducing a serial code composed of the successive numbers corresponding to the successive geometric form objects identified;
   the database storing serial codes associated with the 3D geographical coordinates of at least one of the successive geometric form objects giving rise to the serial code, extracting from the database, from said deduced serial code, 3D geographical coordinates of at least one of the successive geometric form objects associated with the deduced serial code;
the determination of the current 3D position of the machine being as a function of the determined direction and distance of the at least one geometric form object relative to the machine and of the extracted 3D geographical coordinates;
the method comprises the following steps:
   calculating an estimated current position of the machine based upon a 3D position determined in step d at a previous position and estimation of machine move between the previous position and the current position;
   comparing the current 3D position determined by step d with the estimated current position calculated;
   evaluating if the teledetection block is reliable based upon said comparison to determine if the teledetection sensor is working properly;
   the landmark object identified is a circulation signal, and at least one of the following steps is performed:
   the identification of said circulation signal triggers a command to an onboard signal reading block for reading the current aspect of the signal;
   the database storing in association with the circulation signal, the alternative aspects of the circulation signal, the current aspect of the signal detected by an onboard signal reading block is compared with said alternative aspects of the identified signal such as stored in the database; and the detected current aspect is discarded as a function of a comparison of the detected current aspect and of said possible aspects.

According to another aspect, the invention describes a computer program adapted to be stored in the memory of a electronic data processing device and further comprising a microcomputer, said computer program including instructions which, when executed on the microcomputer, implement the steps of a method according to the first aspect of the invention.

According to another aspect, the invention describes a data processing device aimed to be positioned onboard a machine adapted to move on at least one predetermined path; said data processing device including:
a database storing definition data of landmark objects along the predetermined path definition data of each landmark object being associated to its 3D geographical coordinates;
a capture block providing images of the scene in front of the machine, said capture block including at least a teledetection block adapted for emitting waves towards the path in front of the machine, for receiving echoes of emitted waves from at least one echoing object, to create an image from the received echos and to calculate from said waves and echoes, direction and distance, relative to the machine, of said echoing object;
wherein:
the capture block is adapted to capturing a set of images of the current scene comprising at least one image from the teledetection block;
the data processing device being adapted to identify in said image a landmark object as a function of landmark object definition data in the database and, using the image from the teledetection block, to determine direction and distance, relative to the machine, of the identified landmark object;
the data processing device being further adapted to determine the current 3D position of the machine as a function of said determined direction and distance relative to the machine and of the 3D geographical coordinates associated with the identified landmark object in the database.

In embodiments, such a device is adapted to, based on a roughly estimated position of the machine and for identifying in said image a landmark object as a function of landmark object definition data in the database, to determine, among the landmark objects defined in the database, a subset of the landmark objects distant at most of a threshold distance from said roughly estimated position of the machine;
the identification of a landmark object being performed by the data processing device only considering the determined subset as comprising the landmark object to be identified excluding the landmark objects out of the subset.

### BRIEF DESCRIPTION OF THE DRAWINGS

The invention will be better understood and other characteristics, details and advantages will appear better on reading the following description, given without limitation, and thanks to the appended figures, given by way of example.

FIG. 1 is a schematic view of the train 1 circulating on a track;

FIG. 2 is a schematic view of a processing device in an embodiment of the invention;

FIG. 3 represents steps of an processing data method in an embodiment of the invention performing train localization;

FIG. 4 illustrates calculation of the train localization according to an embodiment of the invention;

FIG. 5 is an illustration of a landmark object of type QR code used in an embodiment of the invention;

FIG. 6 is an illustration of a landmark object of type station platform used in an embodiment of the invention;

FIG. 7 is an illustration of a landmark object of type flood gate used in an embodiment of the invention;

FIG. 8 is an illustration of a landmark object information of type flood gate used in an embodiment of the invention;

FIG. 9 is an illustration of geometrical landmark objects used in an embodiment of the invention;

FIG. 10 is an illustration of detection of geometrical landmark objects in an embodiment of the invention;

FIG. 11 is an illustration of detection of geometrical landmark objects in an embodiment of the invention.

Identical references can be used in different figures when they designate identical or comparable elements.

### DETAILED DESCRIPTION

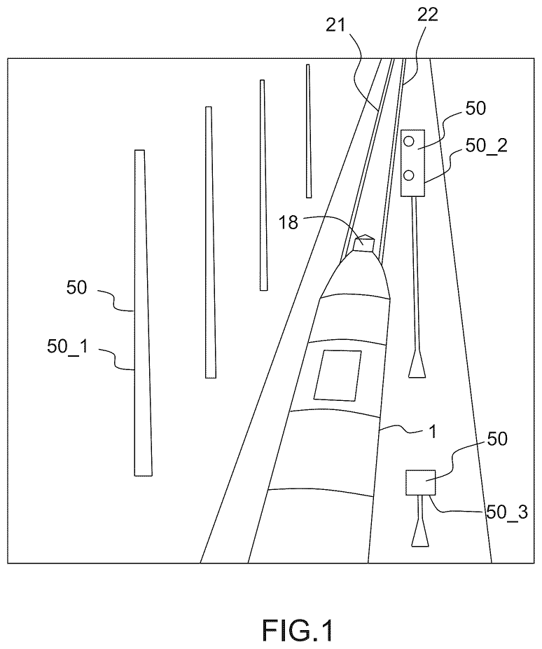

The description of the invention is performed herebelow referring to an embodiment with a train 1. The train 1 is adapted to circulate on a railway track network comprising a plurality of tracks. FIG. 1 represents schematic view of the train 1 circulating on a track including rails 21, 22. Train 1 is manually or autonomously drived.

The train 1 comprises for example a locomotive facing the further portion of the track to be taken by the train and pulling some wagons of the train.

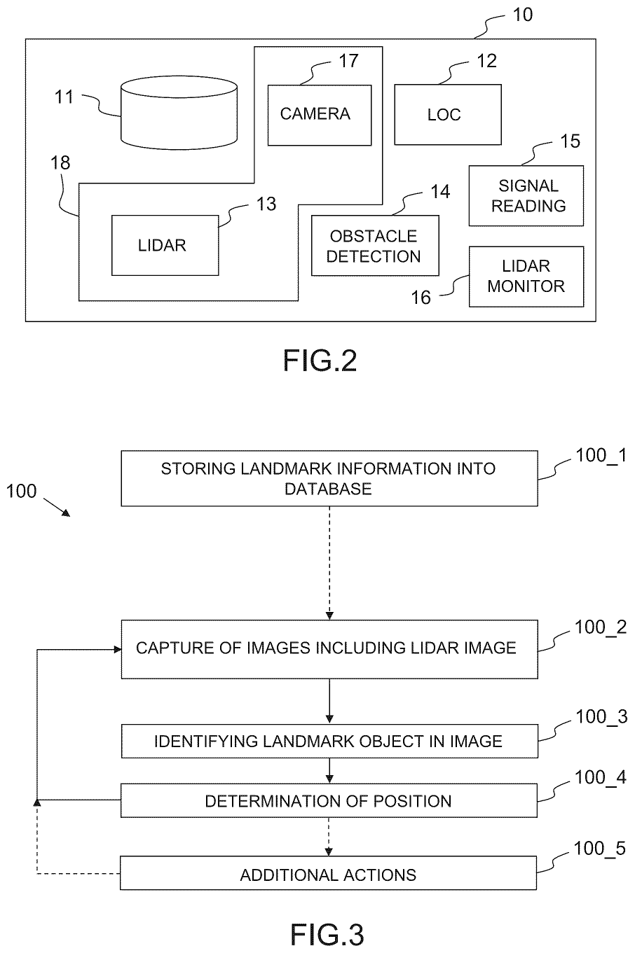

FIG. 2 shows an electronic processing device 10 aboard the train 1. The processing device 10 includes a database 11, a location block 12 and an image capture block 18 including a LIDAR block 13.

The location block 12 is adapted to determine the position of the train 1 each time period T1 (for example T1 is in the range from 50 to 500 ms). The location block 12 for example provides the absolute position of the train 1 on the earth, for example its 3D absolute coordinates.

The LIDAR («Laser Imaging Detection and Ranging») block 13 is installed on the front of the train locomotive, facing the portion of the track ahead the train 1, as shown in FIG. 3.

As known, the LIDAR block 13 includes at least one laser source adapted to emit a laser pulses and includes sensors. Emitted laser pulses, when meeting objects, are reflected by these objects: some of these echoes are received back by the LiDAR block 13 and captured by the sensors. Based upon the measures by the sensors of the received echoes, the LiDAR block 13 is adapted to measure the travel time of the laser echoes and to calculate the distance from the source to each reflecting object and also the direction of this object compared to a reference axis, for example the longitudinal axis of the train locomotive. A 3D picture of the objects in the field of view of the LIDAR block 13 can thus be obtained at time period T2 (for example T2 is in the range from 50 to 500 ms).

The laser source is installed—and the emission of the LIDAR is tuned—in such a way that the LIDAR field of view covers all the objects to be detected along the track, which are close to the track without any intrusion.

Scan speed of the LIDAR block 13 influences the number of points and echoes that are measured. The choice of optics and of scanner greatly influences the resolution and range of the LiDAR system. The range of the LIDAR is the length of the area in front of the train that can be monitored through the laser waves.

In an embodiment the database 11 stores data disclosing track network topology, enabling the knowledge of the 3D coordinates of each point of the rail network track or at least an accurate approximation.

For example, each track being represented by the median axis between the right and link rails of the track:
the median axis having been segmented into successive portions, each portion has been modelized by a segment; the succession of segments is stored in the database for example by chaining their identifier, the form and 3D geographical coordinates end points are known and stored in the database 11; and/or
the database 11 stores the 3D coordinates of a set of points along the median axis, the succession of this points being indicated in the database 11 for example by chaining their identifier and the distance between each point and its next point being equal or less than a predetermined distance d; for example d is in the range from 0 to 5000 m; d is for example chosen equal to 1 meter (m); for example, this embodiment is considered hereafter: FIG. 6 shows in a given plan P perpendicular to a track plane, the point 20 in the median axis between rail 21 and rail 22 of the track.

The database 11 stores also data defining landmark objects that are present along the track. These landmark objects are physical objects that are adapted to LIDAR, i.e. adapted to reflect incident LIDAR waves. Examples of landmark object type are: signal element (with traffic lights) for example 50_2 referring to FIG. 1, pylons for example 50_1, KM Posts such as 50_3, that indicates a number of kilometers separating the KM Post from a reference point, flood gates, supports with QR codes, station platforms, marker boards, including mileage boards and other markers, elements having typical geometry figures.

The database 11 stores for each defined landmark object its type, its ID, its coordinates, other attributes such as landmark linking information, direction in which the landmark can be detected, contents can be read from the landmark, etc.

In an embodiment, characteristic features of the landmark objects are stored: 3D coordinates of the object vertices in a geographical referential global linked to the Earth (for example latitude, longitude), enabling the landmark objects to be recognized, and thus identified, as a function of the received LIDAR echoes.

FIG. 3 represents steps of an processing data method 100 in an embodiment of the invention performing train localization

In a preliminary step 100_1, the definition data, including the 3D geographical coordinates of the characteristic point(s) of the landmark objects 50 along the whole track (from the departure point to the final destination point) are determined and are stored in the database 11.

For example, the landmark objects can be modelized by 3D standard geometrical volumes and/or surfaces associated to geometric parameters including their characteristic dimensions and the coordinates (for example obtained via GNSS receiver or by using mobile topography associated with an inertial measurement unit) of the characteristic vertices of the modelization form.

### Localisation

The exact localization of the train is unknown.

In operation mode of the processing device 100, in a step 100_2, at least a LIDAR image is captured each period T2.

In a step 100_3, each period T1, the localization block 12 analyses an image of an image set including at least the last captured LIDAR image, said image being in an embodiment the last captured LIDAR image, determines one or several point subsets in the image corresponding to respective one or several objects that are source of echoes. Based at least upon said point subset in said image compared to the landmark object information (characteristic vertices, dimensions . . . ), the localization block 12 searches for the landmark object into the database 11, finds it and determines all the possible IDs of this landmark represented in the image, since the landmarks can be almost identical to distinguish. Then the train moves until the next landmark. Based on the detection and the distance to the first landmark, the IDs of the landmark is further screened. This process does on until a unique landmark ID can be identified. The train position is then determined based on this landmark. At the points where trains make often cold start, landmarks with contents can be read can be installed, e.g. QR code. In this case, the ID of the first detected landmark can be read and the position can be determined.

In an embodiment, based upon the last localisation determined with the previous process iteration, and knowing a maximal/minimal speed (fixed or determined from an roughly estimated speed), a subset of the landmark objects distant at most/at least of a first threshold distance (equal to the maximal/minimal speed multiplied by T1) from said last localization of the train is extracted from the database 11, and the identification step is performed by comparing the landmark object in the image only to said subset (and not to landmark objects outside the subset) in order to identify said landmark object.

In another embodiment, the localization block 12 is adapted to perform, in parallel of the process 100, a rough estimation of the current train position (for example with an odometer or a inertial measurement unit), and knowing a maximal position error relative to this estimation, a subset of the landmark objects distant at most of a second threshold distance from said last localization of the train is extracted from the database 11, and the identification step is performed by comparing the landmark object in the image only to said subset (and not to landmark objects outside the subset) in order to identify said landmark object.

Once a landmark object identified in the LIDAR image, in a step 100_4, the location block 12 determines from the LIDAR information related to this landmark object, the relative distance and direction of the identified object in regard to the train.

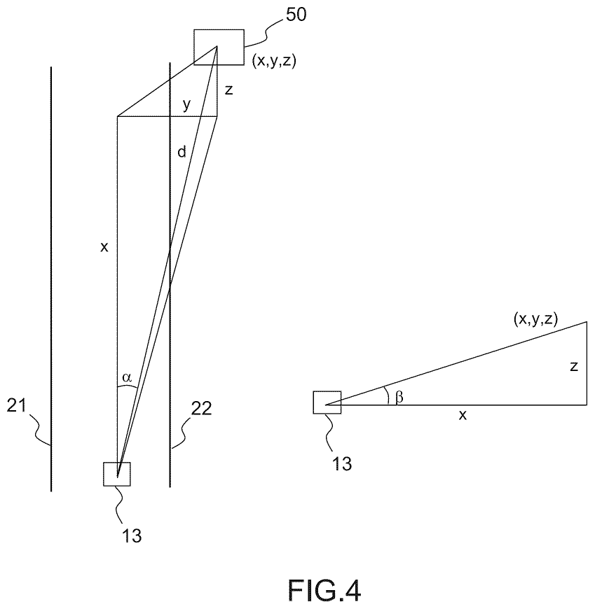

For example, referring to FIG. 4, considering the identified landmark object 50, the distance d and the angles α and β (in regard to the median axis between the track rails 21, 22) are determined.

Moreover, the location block 12 extracts from the database 11 the 3D coordinates of the identified landmark object 50. Referring to FIG. 4, these coordinates are (x, y, z). And from these extracted coordinates combined with the relative distance and direction angles, the discrete and absolute position of the train, expressed in 3D coordinates, is calculated.

In an embodiment, the processing device 10 further includes a video camera 17 positioned on the front face of the train 1, for example with the (roughly) same field of view central axis as the LIDAR 13. The video camera 17 is adapted to capture periodical images of the scene ahead the train 1. It is easier to use camera to distinguish the type of the objects detected, by using already well developed detection models via artificial intelligence.

In such embodiment, in step 100_2, the video camera captures a video image each period T3, that is added to the current image set. And in step 100_3, for example, the identification of landmark objects is performed into the video image. And in order to guaranty that the landmark object considered into the LIDAR image in step 100_4 is the same as the same as the identified landmark object into the video image, a geometrical transformation of the 3D LIDAR image of the set of image is performed into the 2D video image; and then a matching of the identified landmark object image point is performed from the video image towards the transformed 3D LIDAR image; thus indicating which LIDAR points are to be considered to obtain the distance and direction information.

In embodiments, QR Code are framed with materials with high reflection rate to be better detected by LiDAR.

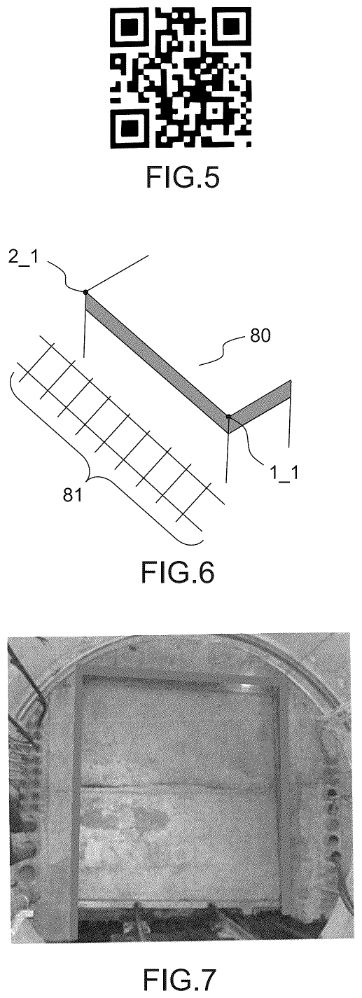

Database 11 includes the following information of the QR code object, referring to FIG. 5:
QR Code ID,
3D geographical coordinates of the QR code center point,
linking information.

The QR Code itself contains the same information.

A QR code object can be identified by LiDAR block 13 by detection on the LIDAR images of the 4 QR code vertices, then by determining to the center point from these vertices with deterministic algorithms.

The contents of the QR code can be read by the camera block 17. By looking up in the database 11, the ID and position of the QR code can be determined, so that the train position can be calculated from the absolute position of the QR Code and ranging from LiDAR.

Referring to FIG. 6, any station platform 80 is defined the key vertices 1_1 and 2_1 (i.e. the top end vertices along the track) and corresponding track segment. Therefore, the information of the landmark objects of the type station platform contained in the database 11 includes in an embodiment:
Station Platform ID,
Track Segment ID,
Vertex 1_1 3D geographical coordinates,
Vertex 2_1 3D geographical coordinates.

The station platforms can be detected by LiDAR block 13 with deterministic algorithms, so that the two vertices can be identified in step 100_3. With the absolute position of the two vertexes from the database 11, the train position can be calculated.

A marker boards can be kilometer posts speed limit board or any other board along the track made of material of high reflection rate. The database 11 includes the following information of marker board type landmark objects:
Marker board ID
3D geographical coordinates of the marker board center point.

Marker board can be detected by LiDAR with deterministic algorithms by detection the vertexes to identify the center point. The train position can be calculated from the absolute position of the marker board and ranging from LiDAR.

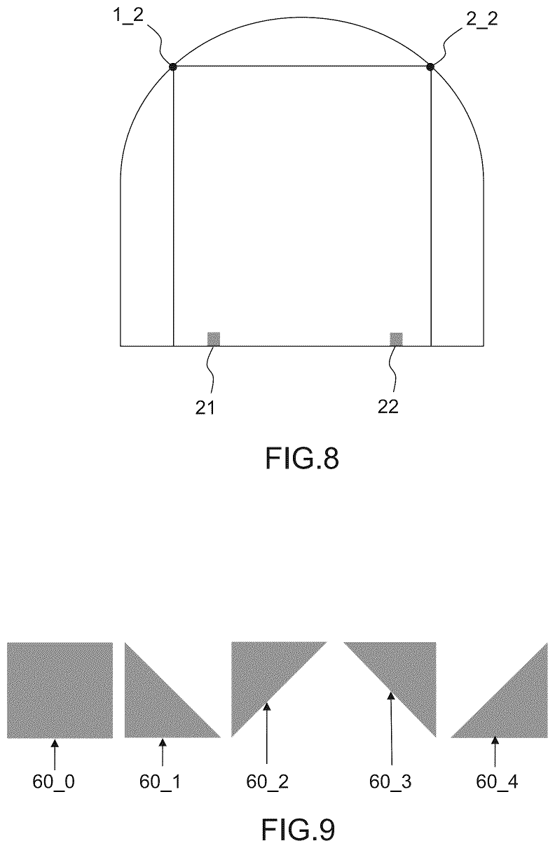

Flood gates are a commonly used facility to prevent water from flowing into the station. FIG. 7 represents a flood gate and FIG. 8 shows the considered characteristics of FIG. 7 flood gate understood as a rectangular. The top most two vertices are defined as 1_2 and 2_2. The two sides of the flood gate are regarded as two landmarks with different coordinates of the vertices, distinguished by the direction in which the flood gate is detected

The information in the database 11 for flood gate type objects includes:
Flood Gate ID
Track Segment ID
Direction, in which it is detected,
Vertex 1_2 3D geographical coordinates,
Vertex 2_2 3D geographical coordinates.

The flood gates can be detected by LiDAR with deterministic algorithms, so that the two vertices 1_2, 2_2 can be identified. With the absolute position of the two vertexes from the database 11, the train position can be calculated. By knowing this information, the detected flood gates will not be regarded as obstacle intruding the train clearance. Detection of flood gates can also monitor the LiDAR behavior.

Geometry figures objects are not natural landmarks, they should be additionally installed.

Objects in form of rectangular and isosceles right triangles with different directions can be the said considered geometry figure objects.

Each figure can stand for one number for example from 0 to 4 in case 5 geometry figures are used.

Referring to FIG. 9, the figure 60_i, 1=0 to 4, corresponds to the number i.

Further to the geometry object detection by the LIDAR 13, the corresponding number is deduced by the localization block 12 (the correspondence between each geometry figure and its associated number having been previously stored in the databased 11.

A serial of the figures successively detected by the localization block 12 forms an ID.

The information in the database 11 for a series of geometric figures includes the identifier of the series, associated with the 3D geographic coordinates of each object constituting a figure of the series (or of at least one of the objects, for example the one corresponding to the last object encountered in a given direction).

The series of numbers constitutes a serial code. It can be considered as a quinary number, each object of which represents a number, from 0 to 4, as digit of the quinary code. If one object is used, it can represent 5 identifiers of length 1, and if, for example, a sequence of 10 objects is used, it can represent 9765625 (5\hat{ }10) identifiers of length 10. These identifiers are indicated in sequence by the track and position of the objects is in the database. Once the complete series is detected, the identifier is obtained, which is an index in the database enabling to find the geolocation of the objects which gave rise to the sequence. Thus, from this geolocation, the position of the train can be calculated.

For example, if the train crosses successively on its trajectory:
an object bearing the geometric figure of type 60_1, then
an object bearing the geometric figure of type 60_3, then
an object bearing the geometric figure of type 60_1, then
an object bearing the geometric figure of type 60_1, then
an object bearing the geometric figure of type 60_3, then
an object bearing the geometric figure of type 60_0,
   the location block 12 deduces the identifier “131130”, then the location block 12 searches in the database 11 for geolocation information stored in correspondence with this identifier: for example this information includes the 3D coordinates of each of said objects encountered, or else the 3D coordinates of one object (for example the last encountered object: here the detected object bearing figure 60_0).

In this case, LiDAR is thus used to detect the type of figure, from what the associated number will be deduced. For example:

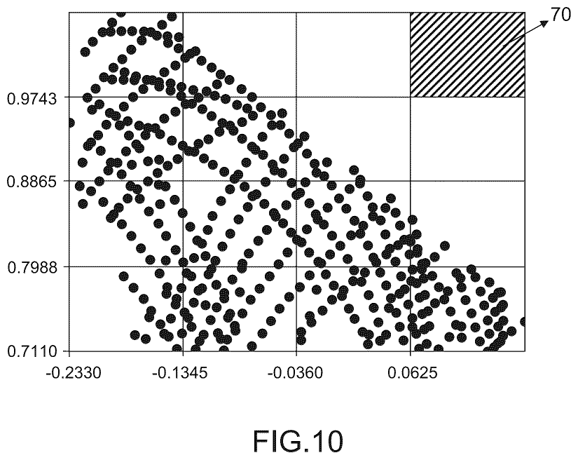

A geometry figures appear on the LiDAR point cloud image as shown in FIG. 10. In an embodiment, the LiDAR point cloud is divided into X (here X=16) identical pieces, such as the hatched piece 70. Only the four pieces at the four vertices of the detected form are used regarding the reflected points. The direction of the triangle can be determined if only three vertices are detected based upon the relative position of the three vertices, and thus the corresponding number 0, 1, 2, 3 or 4. If all four pieces have reflected points on them, it can be determined it is a rectangular.

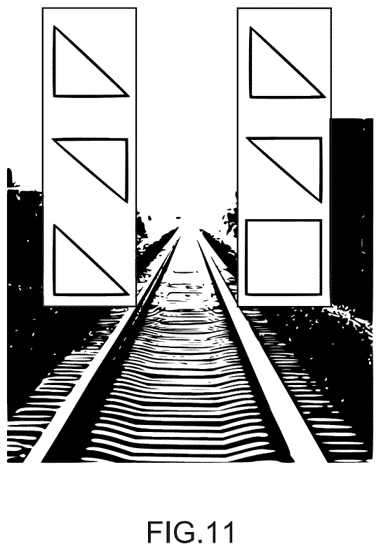

In distinct embodiments, the geometric objects, for example of the type 60_i represented in FIG. 9, are arranged one after the other along the track or they can be grouped at one position of the track, as shown in FIG. 11, in two examples of a series of geometric objects both “coding” the identifier “131130” (if the convention retained in case of grouped objects is that reading is done from top to bottom starting at the left, then from top to bottom at right).

Signals and their aspects (green light in a first position of the light, red light in a second position of the light) can be detected by camera 17. A signal is associated with any of the landmarks (with fixed special distance vector to each other, for example 0 or different from 0) that can be also detected only by LiDAR by detecting the land mark with deterministic algorithms.

The information for signals in the database shall be:
Signal ID,
Associated landmark ID (if applicable), the signal can be associated with a landmark that can be detected by LiDAR using deterministic algorithm, to give accurate ranging of the signal
Spatial difference information (coordinates of the vector between the signal and the associated landmark), by detection and ranging of the landmark with LiDAR, the ranging of the signal can be determined
Track Segment ID,
Signal position, to determine the train position to double check with the position calculated from the LiDAR ranging, to improve safety level
Possible signal aspect, the signal aspect is detected using artificial intelligent, and this information gives a scope of the detection result to improve the integrity of the artificial intelligence algorithm
Signal linking information (o give information of the next signals to be detected).

The set of steps 100_2 to 100_4 is iterated each period T.

In the considered embodiment, additional actions 100_5 are performed optionally. For example, based upon the determined localization or based upon a train speed estimated at least based on the determined localization, an emergency action is triggered, such as an emergency braking. In embodiments, the additional actions 100_5 relate to obstacle detection and/or assisting signal reading function and/or monitoring LIDAR behavior, as described herebelow.

### Obstacle Detection

In an embodiment, the processing device 10 includes an obstacle detection block 14 adapted to detect obstacles around the train 1 and to trigger, based upon such detection, emergency actions such as emergency braking.

The detection of obstacles is performed for example using the LIDAR images or and/or using the video images.

In an embodiment, the invention provides to comparing the estimation of obstacles with and the ground truth defined by the landmark information stored in the database 11.

For example, in step 100_5, using the landmark information in the database 11, the obstacle detection discards, from the detected obstacles, the landmark objects ahead that would have been detected erroneously as obstacles because being very close to the train or because of train position uncertainty or because of sensor errors. The steps would be for example:
During the obstacle detection process, there is slight error of train position and/or sensor attitude. The error is magnified in long distance
Look up in the database 11 at the position of the obstacle to determine if there is a platform or flood gate, or any other things defined in the database 11 close to the track
If no, the obstacle detection module knows it is an obstacle instead of anything close to the track but out of the train clearance
If yes, this obstacle is marked as potential false alarm for obstacle detection module further processing, e.g. to make the determination at a nearer position to the obstacle
   Thus, even if station platforms or floodgates are very close to the track and thus can be easily wrongly detected as obstacle, they will not be regarded as obstacle.

### Facilitating Signal Reading Function

Signal is also a landmark. In an embodiment, the processing device 10 includes a signal reading bloc 15 adapted to determine the signal given by a traffic signaling equipment such as 50_2, for example through determination of the position and colour of the emitted light determined by image processing on a video image provided by the camera block 17.

The landmark information of the signal in the database 11, e.g. position, possible aspects, can provide possibility to reduce the computing load e.g. the detection of signal is only performed from a position to the signal shorter than a certain distance (depending on the detection range, for example 200m) since the signal position is known from the database 11, and as a consistency check reference to improve integrity, whereas without any of this information, the algorithm in the signal reading block 15 would need to look for signal to detect all the time, which consumes a lot of computing power. If a signal aspect is read, the computer vision needs to identify the color of the signal (there may be polarized light which causes the color to be mis-read). The signal landmark information provides reference (possible aspects) to check the reading result, for example, if the signal aspect is detected as an aspect not in the possible aspect list, it is known the detection is wrong.

In the step 100_5, implemented steps are for example:
fusion of LiDAR data and camera data, to identify on the camera image the signal that the LiDAR detects
identify the signal aspect from camera image
look up in database 11 if the identified signal aspect is possible. If yes, this aspect can be used, and if not, the identification result is discarded

### Monitoring LIDAR Behavior

In an embodiment, the processing device 10 includes a LIDAR monitor block 16 adapted to monitor the LIDAR block 13 behavior, with comparison of the detected landmarks in LIDAR images and the landmarks in the database 11.

In the step 100_5, implemented steps are for example:
Look up in the database 11 for the landmarks ahead in view
Use previous accurate position and odometry including odometry error to calculated the current estimated position of the train with tolerant error
If the landmark in database 11 is successfully detected and the position of the train calculated from this landmark is within the tolerant position from odometry, the LiDAR is regarded to be working properly
If not, the LiDAR detection result cannot be relied on.

In embodiments, the processing module 10 performs only one or several mentioned processes using landmarks in the database 11 among localization, obstacle detection, assisting signal reading function and monitoring LIDAR behavior.

In an embodiment, the processing device 10 includes a microprocessor and a memory comprising instructions which, when executed by the microprocessor, implement one or several of the steps 100_1 to 100_5. Alternatively at least some of the steps can be implemented by dedicated hardware, typically a digital integrated circuit, either specific (ASIC) or based on programmable logic (e.g. FPGA/Field Programmable Gate Array).

Due to the constraints of LiDARs performance, the wider the FoV (field of view) is, the lower the point density is. Therefore, it may not be possible to find one single LiDAR to cover both the range and the width. Therefore, multiple LiDARs can be used. In an embodiment, two LiDAR are used or more, instead of only one, for long distance (Field of View FoV1) and short distance (Field of View FoV2) respectively to cover the whole range, as shown in FIG. 4. The benefits include to cover both width and range and that the FoV overlapping space can be detected with both/all the LiDARs to provide independent chains of detection to facilitate safety demonstration.

Of course, numerous landmark objects can be taken into account in the data base 11, detected by LiDAR (and camera in case a camera 17 is also used).

The invention has been disclosed hereabove using a LIDAR block. Other technology can be used instead of LIDAR, for example RADAR or SONAR technology, or any suitable technology using detection of echoes of waves generated aboard the train.

The invention has been disclosed hereabove regarding a train, but is more generally usable relative to any machine movable along any trajectory of a set of known trajectories, such machine being thus for example a metro, a tramway, a boat, a plane, a drone, with or without automatic and autonomous driving.

1. A data processing method implemented by an electronic data processing device (10) onboard a machine (1) adapted to move on at least one predetermined path (21, 22), the data processing device including:
a database (11) storing definition data of landmark objects along the predetermined path, definition data of each landmark object being associated to its 3D geographical coordinates;
a capture block (18) providing images of the scene in front of the machine (1), said capture block including at least a teledetection block (13) adapted for emitting waves towards the path in front of the machine, for receiving echoes of emitted waves from at least one echoing object, to create an image from the received echos and to calculate from said waves and echoes, direction and distance, relative to the machine, of said echoing object;
said method comprising the iterated following steps:
a) capturing by the capture block (18) a set of images of the current scene comprising at least one image from the teledetection block (13);
b) identifying in said image a landmark object (50) as a function of landmark object definition data in the database (11);
c) using the image from the teledetection block (13), determining direction and distance, relative to the machine (1), of the identified landmark object;
d) determining the current 3D position of the machine (1) as a function of said determined direction and distance relative to the machine and of the 3D geographical coordinates associated with the identified landmark object in the database (11).

2. The method according to claim 1, wherein based on a roughly estimated position of the machine (1), the following steps are performed in step b:
determining, among the landmark objects (50) defined in the database (11), a subset of the landmark objects distant at most of a threshold distance from said roughly estimated position of the machine (1);
identification of a landmark object (50) being performed only considering the determined subset as comprising the landmark object to be identified excluding the landmark objects out of the subset.

3. The method according to claim 1, wherein the capture block (18) further includes a camera (17) and the set of images of the current scene includes an image from the camera (17) and an image from the teledetection block (13),
identifying of the landmark object (50) is performed in the image from the camera (17); and
a projection of the image from the teledetection block (13) into the referential of the video image is performed in order to match the representation of the identified landmark object (50) in both images;
determination of the direction and distance, relative to the machine (1), of the identified landmark object (50) is achieved based upon the matched representation of the identified object in the image from the teledetection block (13).

4. The method according to claim 1, wherein the machine (1) is a railway machine and said landmark objects (50) includes objects among: QR codes, station platforms, marker boards, flood gates, geometry figures, signals.

5. The method according to claim 1, wherein landmark objects (50) includes objects with respective geometrical form each associated wherein the database stores a correspondence between the geometrical form and a respective number, comprising the following steps:
identifying geometric form objects along the path (21, 22);
deducing a serial code composed of the successive numbers corresponding to the successive geometric form objects identified;
the database (11) storing serial codes associated with the 3D geographical coordinates of at least one of the successive geometric form objects giving rise to the serial code, extracting from the database (11), from said deduced serial code, 3D geographical coordinates of at least one of the successive geometric form objects associated with the deduced serial code;
determination of the current 3D position of the machine (1) being as a function of the determined direction and distance of the at least one geometric form object relative to the machine and of the extracted 3D geographical coordinates.

6. The method according to claim 1, further comprising the following steps:
calculating an estimated current position of the machine (1) based upon a 3D position determined in step d at a previous position and estimation of machine move between the previous position and the current position;
comparing the current 3D position determined by step d with the estimated current position calculated;
evaluating if the teledetection block (13) is reliable based upon said comparison to determine if the teledetection sensor is working properly.

7. The method according to claim 1, wherein the landmark object (50) identified is a circulation signal, and at least one of the following steps is performed:
identification of said circulation signal triggers a command to an onboard signal reading block (15) for reading the current aspect of the signal;
the database (11) storing in association with the circulation signal, the alternative aspects of the circulation signal, the current aspect of the signal detected by an onboard signal reading block (15) is compared with said alternative aspects of the identified signal such as stored in the database; and the detected current aspect is discarded as a function of a comparison of the detected current aspect and of said possible aspects.

8. A computer program, adapted to be stored in the memory of a electronic data processing device (10) and further comprising a microcomputer, said computer program including instructions which, when executed on the microcomputer, implement the steps of a method according to claim 1.

9. A data processing device (10) aimed to be positioned onboard a machine (1) adapted to move on at least one predetermined path (21, 22); said data processing device including:
a database (11) storing definition data of landmark objects along the predetermined path definition data of each landmark object being associated to its 3D geographical coordinates;
a capture block (18) providing images of the scene in front of the machine (1), said capture block including at least a teledetection block (13) adapted for emitting waves towards the path in front of the machine, for receiving echoes of emitted waves from at least one echoing object, to create an image from the received echos and to calculate from said waves and echoes, direction and distance, relative to the machine, of said echoing object;
wherein:
the capture block (18) is adapted to capturing a set of images of the current scene comprising at least one image from the teledetection block (13);
the data processing device being adapted to identify in said image a landmark object (50) as a function of landmark object definition data in the database (11) and, using the image from the teledetection block (13), to determine direction and distance, relative to the machine (1), of the identified landmark object;
the data processing device being further adapted to determine the current 3D position of the machine (1) as a function of said determined direction and distance relative to the machine and of the 3D geographical coordinates associated with the identified landmark object in the database (11).

10. The data processing device (10) according to claim 9, adapted to, based on a roughly estimated position of the machine (1) and for identifying in said image a landmark object (50) as a function of landmark object definition data in the database (11), to determine, among the landmark objects (50) defined in the database (11), a subset of the landmark objects distant at most of a threshold distance from said roughly estimated position of the machine (1);
the identification of a landmark object (50) being performed by the data processing device (10) only considering the determined subset as comprising the landmark object to be identified excluding the landmark objects out of the subset.
